(19) United States
(12) Patent Application Publication
(10) Pub. No.: US 2006/0031637 A1
(43) Pub. Date: Feb. 9, 2006

(54) Disk array device group and copy method for the same

(75) Inventors: Kousuke Komikado, Odawara (JP); Koji Nagata, Kaisei (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 10/954,444

(22) Filed: Oct. 1, 2004

(30) Foreign Application Priority Data
Aug. 3, 2004 (JP) 2004-227008

(51) Int. Cl. G06F 12/16

(52) U.S. Cl. 711/114; 711/162

(57) ABSTRACT

This invention provides copy techniques for a disk array device group effectively applied to the process wherein multigenerational differential data group controlled by local side storage is remote-copied to remote side storage and controlled therein, while maintaining the data consistency between the multigenerational differential data groups. The system has a disk array device of a local site and a disk array device of a remote site. In this system, control is performed so that data of plural sub-volumes of the disk array device on the local site side are remote-copied to a primary volume of the disk array device on the remote site side, and a pair state and pair cancellation between a primary volume and each of the sub-volumes can be controlled even during the remote copy. Further, when creating sub-volumes, differential data from previous data of the sub-volumes are created and stored into the sub-volumes.

### CROSS-REFERENCE TO RELATED APPLICATION

The present application claims priority from Japanese Patent Application No. JP 2004-227008 filed on Aug. 3, 2004, the content of which is hereby incorporated by reference into this application.

### TECHNICAL FIELD OF THE INVENTION

The present invention relates to copy techniques for a disk array device group. More particularly, the invention relates to the techniques effectively applied to the process wherein multigenerational differential data group controlled by local side storage is remote copied to remote side storage and is controlled therein, while maintaining the data consistency between the multigenerational differential data groups.

### BACKGROUND OF THE INVENTION

According to the results of researches and investigations conducted by the inventors of the present invention, the followings are known as the conventional copy techniques for disk array device groups.

Usually, in the remote backup in the copy techniques for disk array device groups, the multiple creation of the backup data can be performed by mirroring the data of a primary site at a secondary site located in a geographical area different from the primary site. In this multiple creation of the backup data, a technique called a snapshot is used, which makes it possible to reference the original data at a certain time point even when the original data is updated after the certain time point, while maintaining the consistency at a certain time point between a storage volume storing the original data and a storage volume storing replicated data.

By way of example, a technique relevant to the above is disclosed in Japanese Patent Application Laid-Open No. 2003-242011. In this technique, data of a primary storage device located in a local site is mirrored to a secondary storage device located in a remote site, and the snapshots of the primary and secondary storage devices are created respectively, and then, the snapshot of the primary storage device is preserved in a snapshot volume of the local site and the snapshot of the secondary storage device is preserved in a snapshot volume of the remote site. Thereafter, the above processes are repeated. In this manner, the multigenerational preservation of the snapshots is carried out.

### SUMMARY OF THE INVENTION

As a result of the researches and investigations by the inventors of the present invention regarding the above-described conventional copy techniques for disk array device groups, the followings are shown.

For example, according to the techniques disclosed in Japanese Patent Application Laid-Open No. 2003-242011, data in the primary storage device is mirrored to the secondary storage device, and the snapshot of the primary storage device is preserved in the snapshot volume of the local site, and the snapshot of the secondary storage device is preserved in the snapshot volume of the remote site. Therefore, the required storage capacity is increased, and hence, the load of a host I/O (input/output) is increased. Consequently, it becomes necessary to use high-speed circuits.

Accordingly, an object of the present invention is to provide copy techniques for a disk array device group capable of solving the above-described problems and effectively applied to the process wherein a multigenerational differential data group controlled by a local side storage is remote copied to a remote side storage and controlled therein while maintaining the data consistency between the multigenerational differential data groups.

The above and other objects and novel characteristics of the present invention will be apparent from the description and the accompanying drawings of this specification.

The representative ones of the inventions disclosed in this application will be briefly described as follows.

The present invention is applied to a disk array device group and a copy method for the same, and the disk array device comprises: a first disk array device present in a first location; and a second disk array device present in a second location, wherein remote copy is performed from the first disk array device to the second disk array device. The present invention has the characteristics as follows.

That is, in the present invention, at least one of the first disk array device and the second disk array device comprises: an upper interface that is connected to an upper machine and that receives data from the upper machine; a memory that is connected to the upper interface and that preserves data communicated with the upper machine and control information regarding data communicated with the upper machine; a disk interface that is connected to the memory and that controls the data communicated with the upper machine to be read and written from and to the memory; a plurality of disk drives that are connected to the disk interface and that store data sent from the upper machine under control of the disk interface; and a control processor that controls read and write of data from and to a first logical volume created by using storage areas of the plurality of disk drives, performs control so that past data stored in the first logical volume is written as differential data of each generation to a second logical volume, and controls the differential data by providing a snapshot control table, which is used to control relationships of the differential data of each generation stored in the second logical volume, into an area of the memory, and a function to create at least a first virtual logical volume for storing first generation data and a second virtual logical volume for storing second generation data in accordance with the snapshot control table is provided.

More specifically, in the first technique of the present invention, the first disk array device comprises the upper interface, the memory, the disk interface, the plurality of disk drives, the control processor, and has a function to create the first virtual logical volume and the second virtual logical volume, and the control processor of the first disk array device has a function to perform control so that data of the first virtual logical volume is transferred to be remote copied to a third logical volume of the second disk array device and data of the second virtual logical volume is transferred to be remote copied to a fourth logical volume of the second disk array device. Furthermore, during the transfer for the remote copy, pair creation and pair split between the first logical volume and the first virtual logical volume and between the first logical volume and the second virtual logical volume are controlled, and when one of them is in a pair state, the other pair is cancelled. In addition, when creating each virtual logical volume, differential data from the previous data of a virtual logical volume is created and stored into the virtual logical volume.

Also, in the second technique of the present invention, the second disk array device comprises the upper interface, the memory, the disk interface, the plurality of disk drives, and the control processor, and has a function to create the first virtual logical volume and the second virtual logical volume, and the control processor of the second disk array device has a function to perform control so that data transferred from the first disk array device to be remote copied is stored into a fifth logical volume and the first virtual logical volume and the second virtual logical volume are created from the fifth logical volume. Furthermore, during the transfer for the remote copy, pair creation and pair split between the fifth logical volume and the first virtual logical volume and between the fifth logical volume and the second virtual logical volume are controlled, and when one of them is in a pair state, the other pair is cancelled. In addition, when creating each virtual logical volume, differential data from the previous data of a virtual logical volume is created and stored into the virtual logical volume.

Also, in the third technique of the present invention, the first disk array device and the second disk array device each comprises the upper interface, the memory, the disk interface, the plurality of disk drives, and the control processor, and has a function to create the first virtual logical volume and the second virtual logical volume, and the control processor of the first disk array device has a function to perform control so that data of the first virtual logical volume and the second virtual logical volume of the first disk array device are transferred to be remote copied to a sixth logical volume of the second disk array device, and the control processor of the second disk array device has a function to perform control to store data transferred from the first disk array device to be remote copied into the sixth logical volume and create the first virtual logical volume and the second virtual logical volume of the second disk array device from the sixth logical volume. Furthermore, in the first disk array device, during the transfer for the remote copy, pair creation and pair split between the first logical volume and the first virtual logical volume and between the first logical volume and the second virtual logical volume are controlled and when one of them is in a pair state, the other pair is cancelled. In addition, when creating second virtual logical volume, differential data from the data of the first virtual logical volume is created and stored into the second virtual logical volume.

The effect obtained by the typical ones of the inventions disclosed in this application will be briefly described as follows.

According to the present invention, a multigenerational differential data group controlled by a local side storage can be remote copied to a remote side storage and can be controlled therein, while maintaining the data consistency between the multigenerational differential data groups.

### BRIEF DESCRIPTIONS OF THE DRAWINGS

FIG. 1 is a block diagram showing the configuration of a system including a disk array device according to an embodiment of the present invention;

FIG. 2 is an explanatory diagram showing the configuration of a control program in a system including a disk array device according to an embodiment of the present invention;

FIG. 3 is an explanatory diagram showing a first example of the remote copy in a system including disk array devices according to an embodiment of the present invention;

FIG. 4 is an explanatory diagram showing a second example of the remote copy in a system including disk array devices according to an embodiment of the present invention;

FIG. 5 is an explanatory diagram showing a third example of the remote copy in a system including disk array devices according to an embodiment of the present invention;

FIG. 6 is an explanatory diagram showing a snapshot for each day of a week in the third example of remote copy in a system including disk array devices according to an embodiment of the present invention;

FIG. 7 is a flowchart showing a snapshot operation in the third example of the remote copy in a system including disk array devices according to an embodiment of the present invention;

FIG. 8 is an explanatory diagram showing the operation from QuickShadow to the remote copy in a system including disk array devices according to an embodiment of the present invention;

FIG. 9 is an explanatory diagram showing a snapshot pair creation registration sequence in a system including disk array devices according to an embodiment of the present invention;

FIG. 10 is an explanatory diagram showing the display of a snapshot pair creation in a system including disk array devices according to an embodiment of the present invention;

FIG. 11 is an explanatory diagram showing a snapshot pair cancellation sequence in a system including disk array devices according to an embodiment of the present invention;

FIG. 12 is an explanatory diagram showing the operation of a saved data deletion job program in a system including disk array devices according to an embodiment of the present invention;

FIG. 13 is an explanatory diagram showing a pair (first pair) forming process sequence in a system including disk array devices according to an embodiment of the present invention;

FIG. 14 is an explanatory diagram showing a pair (second and subsequent pair) forming process sequence in a system including disk array devices according to an embodiment of the present invention;

FIG. 15 is an explanatory diagram showing a sub-VOL deletion process sequence in a system including disk array devices according to an embodiment of the present invention;

FIG. 16 is an explanatory diagram showing a pair cancellation process sequence in a system including disk array devices according to an embodiment of the present invention;

FIG. 17 is an explanatory diagram showing a pair re-synchronization process sequence in a system including disk array devices according to an embodiment of the present invention;

FIG. 18 is an explanatory diagram showing a pool cancellation process sequence in a system including disk array devices according to an embodiment of the present invention;

FIG. 19 is an explanatory diagram showing a sub-VOL creation process sequence in a system including disk array devices according to an embodiment of the present invention; and

FIG. 20 is an explanatory diagram showing a pool definition process sequence in a system including disk array devices according to an embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

(Outline of the Invention)

The present invention is applied to a disk array device group and a copy method for the same. The disk array device group has a first disk array device residing at a local site in a first location and a second disk array device residing at a remote site in a second location, wherein remote copy from the first disk array device to the second disk array device is performed.

The first disk array device and the second disk array have a front end (upper) interface, a memory, a back end (disk) interface, a plurality of disks (disk drives), and a CPU (control processor). The front end (upper) interface is connected to a host (upper machine) to receive data from the host. The memory is connected to the front end interface and preserves data communicated with the host and control information regarding the data. The back end (disk) interface is connected to the memory and controls data communicated with the host so that the data is read and written to the memory. The plurality of disks (disk drives) are connected to the back end interface and store data sent from the host under control of the back end interface. The CPU (control processor) controls read and write of data to a primary volume (first logical volume) formed by using storage areas of the plurality of disks, performs control so that past data stored in the primary volume is written as differential data of each generation to a pool volume (second logical volume), and executes a control program that controls differential data by providing a snapshot control table, which is used to control the relationships of the differential data of each generation stored in the pool volume, into a memory area. At least a sub-volume 1 (first virtual logical volume) for storing first generation data and a sub-volume 2 (second virtual logical volume) for storing second generation data are provided in accordance with the snapshot control table.

(Configuration of System Including Disk Array Device)

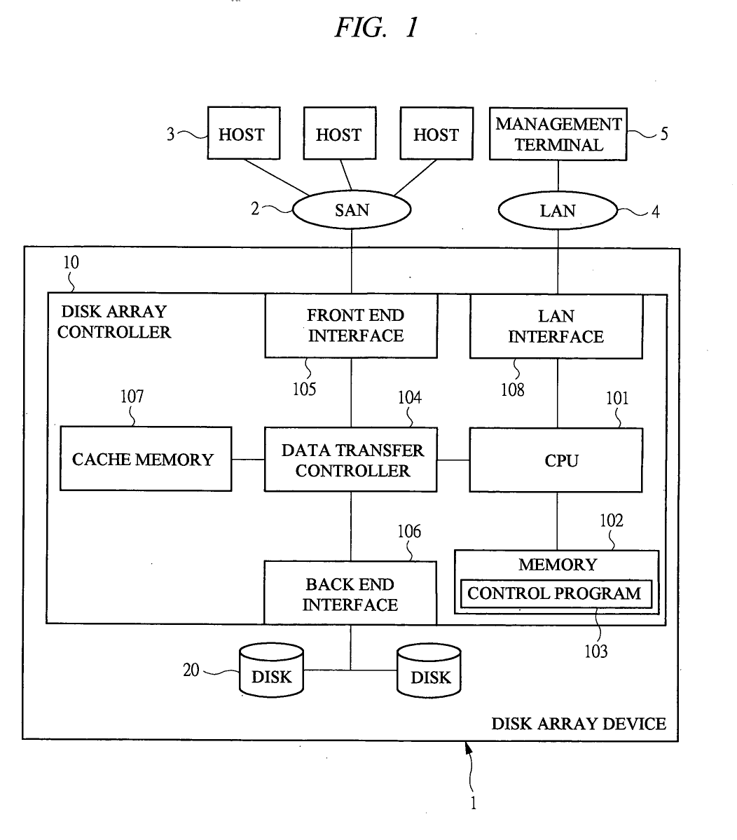

An example of the configuration of a system including the disk array devices according to this embodiment will be described with reference to FIG. 1. FIG. 1 is a block diagram showing the configuration of a system including a disk array device.

A disk array device 1 according to this embodiment includes a disk array controller 10 and disks 20. The disk array device 1 is connected to a plurality of hosts 3 via a SAN (Storage Area Network) 2 and is connected to a management terminal 5 via a LAN (Local Area Network) 4.

The disk array controller 10 controls input/output of data to the disks 20 in accordance with the operation of a control program 103. The disks 20 form the RAID (Redundant Array of Independent Disk) thereby providing the redundancy of data to be stored. Accordingly, even when the disks 20 partly cause failure, the stored data is not lost.

Furthermore, the disk array controller 10 is provided with a CPU 101, a memory 102, a data transfer controller 104, a front end interface 105, a back end interface 106, a cache memory 107, and a LAN interface 108.

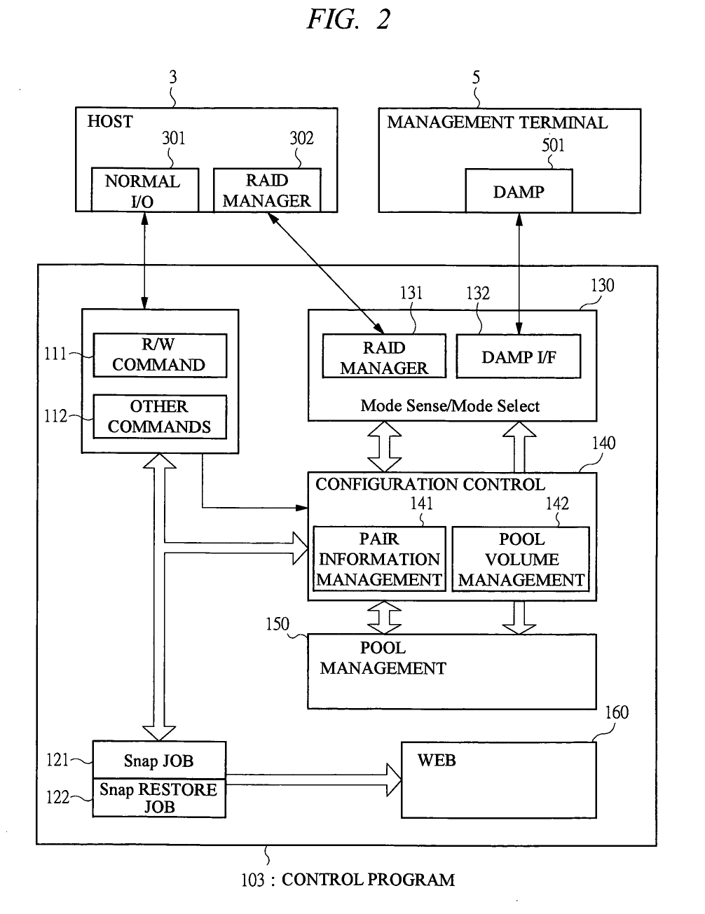

In the memory 102, the control program 103 (refer to FIG. 2) is stored, and various processes are executed by invoking and executing the control program 103 by the CPU 101. The data transfer controller 104 performs data transfer between itself and the CPU 101, the front end interface 105, the back end interface 106, and the cache memory 107.

The front end interface 105 is an interface for the SAN 2 and performs transmission and reception of data and control signals between itself and the hosts 3 in accordance with, for example, a fiber channel protocol. The back end interface 106 is an interface for the disks 20 and performs transmission and reception of data and control signals between itself and the disks 20 in accordance with, for example, a fiber channel protocol.

The cache memory 107 is provided with a cache for temporarily storing data transmitted and received between the front end interface 105 and the back end interface 106. That is, the data transfer controller 104 transfers the data, which is read and written from and to the disks 20 via the SAN 2, between the front end interface 105 and the back end interface 106. Further, the data transfer controller 104 transfers the data read and written from and to the disks 20 to the cache memory 107.

The LAN interface 108 is an interface for the LAN 4 and is capable of transmitting and receiving data and control signals between itself and the management terminal 5 in accordance with, for example, a TCP/IP protocol. The SAN 2 is a network across which data can be communicated in accordance with a protocol suitable for data transfer such as the fiber channel protocol.

The host 3 is a computer device that includes a CPU, a memory, a storage device, an interface, an input unit, and a display device. The host 3 processes the data provided from the disk array device 1 so as to make the database services and web services usable. The LAN 4 is used to control the disk array device 1 and enables inter-computer communication of data and control information in accordance with, for example, a TCP/IP protocol. More specifically, Ethernet (registered trademark) is used for the LAN 4.

The management terminal 5 is a computer device that includes a CPU, a memory, a storage device, an interface, an input unit, and a display device. In the management terminal 5, a management program is provided, and the operation state of the disk array device 1 is acquired through the management program so as to control the operation of the disk array device 1. A client program such as a Web browser is operated in the management terminal 5, and it is also possible to control the operation of the disk array device 1 by a management program provided through, for example, CGI (Computer Gateway Interface).

(Configuration of Control Program)

An example of the configuration of the control program in the system including the disk array device according to this embodiment will be described with reference to FIG. 2. FIG. 2 is an explanatory diagram showing the configuration of the control program.

A data I/O request sent from a normal I/O processing program 301 of the host 3 is analyzed by an R/W command analysis program 111 of the control program 103 of the disk array device 1 and is sent to a snap job program 121. Upon receipt of a data write request to a primary volume, at the time of the write operation to the primary volume, the snap job program 121 copies the data in the primary volume into a pool volume serving as a storage area thereof before its update, and then, the contents of the primary volume is updated after the copy.

At the time of reception of a snapshot creation request, the snap job program 121 updates a snapshot control table (differential information control block) so that a block in a virtual volume corresponding to a block in the primary volume with the updated data is correlated with a block in a pool volume storing the data of the primary volume (i.e., data before updated).

Also, a snap restore job program 122 performs the restoration process from a snapshot sub-volume to a primary volume.

In this manner, the disk array device 1 can provide a snapshot image. Also, when the host 3 has an access to the virtual volume via the normal I/O processing program 301, the host 3 is allowed to use information in the primary volume at a time when the snapshot creation request is issued.

In addition, a control command sent from the normal I/O processing program 301 is analyzed by other command analysis program 112 and is sent to a configuration information control program 140. Upon receipt of the snapshot creation request, a pair information management program 141 of the configuration information control program 140 first registers identification information of a new virtual volume into the snapshot control table. Initially, the blocks in the virtual volume are correlated in a one-to-one manner with the blocks in the primary volume by means of the snapshot control table.

As described later, a pool volume management program 142 manages addition and deletion of volumes registered in pool areas. A pool management program 150 manages pools themselves in accordance with the pool volume management program 142. Also, a WEB program 160 is provided to deploy jobs on the WEB.

Furthermore, a RAID manager program 131 provided in the control program 103 of the disk array device 1 is communicably connected to a RAID manager program 302 of the host 3. The RAID manager programs 131 and 302 enable processes such as snapshot creation, remote copy creation, and pair state alteration.

In addition, a DAMP interface program 132 is communicably connected to a DAMP program 501 of the management terminal 5. In accordance with the DAMP interface program 132, the communication with the DAMP program 501 of the management terminal 5 is performed, which makes it possible to manage the RAID configuration of the disk array device 1.

### FIRST EXAMPLE OF REMOTE COPY

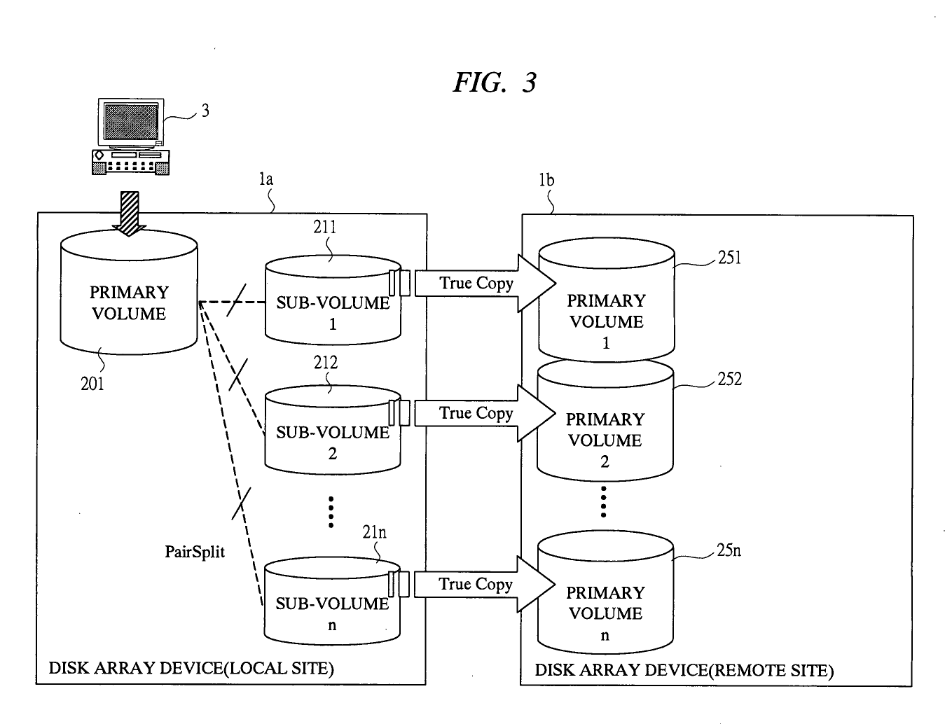

A first example of remote copy between disk array devices in a disk array device group will be described with reference to FIG. 3. FIG. 3 is an explanatory diagram showing the first example of the remote copy.

In a system shown in FIG. 3, a plurality of disk array devices 1 shown in FIGS. 1 and 2 are provided to form a disk array device group. In this system, remote copy operations are constantly and repeatedly executed from a disk array device 1a of a local site connected to the host 3 to another disk array device 1b of a remote site.

In the disk array device 1a provided at the local site, a primary volume 201, which is a logical volume, and a plurality of sub-volumes 211, 212, . . . , 21n (“sub-volumes 211 to 21n,” hereafter), which are virtual logical volumes in accordance with QuickShadow, are provided. Also, a plurality of primary volumes 251, 252, . . . , 25n which are logical volumes are provided for the plurality of sub-volumes 211 to 21n, respectively in a disk array device 1b of the remote site, and the remote copy is performed to the plurality of primary volumes 251 to 25n.

In this case, the disk array device 1a of the local site has the CPU 101 which controls the read and write of data to the primary volume 201, controls the past data stored in the primary volume 201 so as to be written into the pool volume as the differential data of each generation, and executes the control program 103 for controlling the differential data by providing the snapshot control table, which is used to control the relationships of the differential data of each generation stored in the pool volumes, into the area of the memory 102. Therefore, the sub-volumes 211 to 21n for storing data of each generation can be created in accordance with the snapshot control table. For example, data of individual days of week can be set as the data of each generation. In this case, data of individual days of the week are stored in the individual sub-volumes in such a manner that the sub-volume 211 is used for the data of Monday, the sub-volume 212 is used for the Tuesday, and the like.

In this case, the CPU 101, which executes the control program 103 of the disk array device 1a on the local site side, controls data transfer so that the data in the sub-volumes 211 to 21n are remote copied to the primary volumes 251 to 25n of the disk array device 1b on the remote site side. In addition, during the data transfer for the remote copy, the CPU 101 controls pair creation (PairCreate) and pair split (PairSplit) between the primary volume 201 and the sub-volumes 211 to 21n, and when one path is in a pair state, the pair split of other paths can be done. Further, in an event of creation of each of the sub-volumes 211 to 21n, differential data from the data of the sub-volume of the corresponding day of previous week is created and stored in each individual sub-volume.

The first example of the remote copy solves the following problems of the conventional system. More specifically, in the conventional system, since only one sub-volume can be created on the side of the disk array device of the local site, the pair split cannot be done during the remote copy to the disk array device of the remote site. Therefore, it is necessary to wait the completion of the remote copy to do the next pair split. For example, in the event of the remote copy of a sub-volume with a large differential amount, a huge amount of data is transferred, and hence, it takes much time for the remote copy. As a result, the state where the pair split cannot be done occurs frequently.

In view of the above, in the first example according to this embodiment, it is possible to create the plurality of sub-volumes 211 to 21n in the disk array device 1a of the local site. By doing so, the pair split can be done even during the remote copy of one sub-volume. In this case, when remote copying the sub-volumes 211 to 21n created at the local site, the volumes are copied to the primary volumes 251 to 25n at the remote site, respectively. Consequently, the plurality of sub-volumes can be created at the local site, and thus, it becomes possible to do the pair split even when one sub-volume is used in the remote copy.

For example, the remote copy of data of the days of week from Monday to Friday is as follows: (1) the differential in data of Monday (differential data from data of Monday (data of Monday of the previous week) on remote site side) is remote copied to the remote site side; (2) the differential in data of Tuesday (differential data from data of Tuesday (data of Tuesday of the previous week) on the remote site side) is remote copied to the remote site side; thereafter, differentials in data of Wednesdays, Thursdays, and Fridays are similarly remote copied to the remote site side. Then, differential data of one week is sent from the local site to the remote site every day in the period from Monday to Friday.

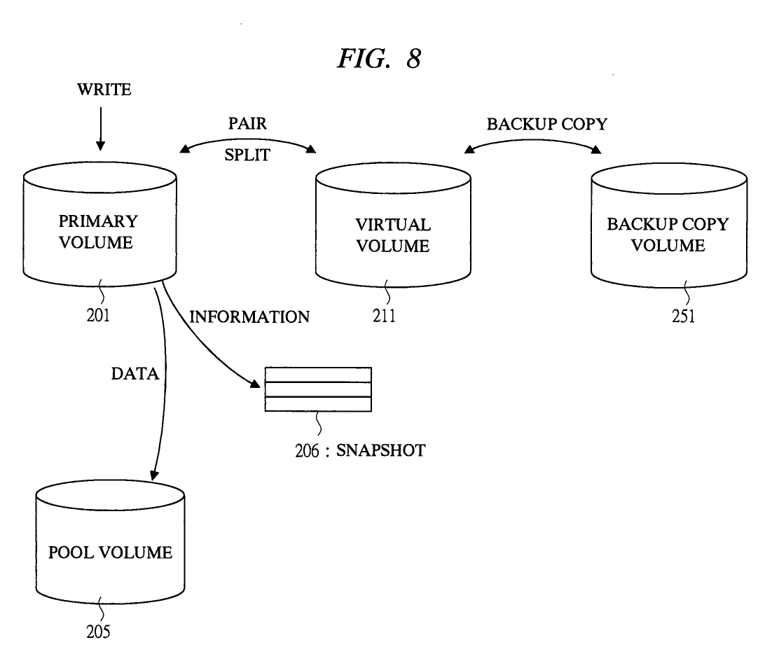

More specific operations will be described below in a third example in the form of a combination of the above-described first example and a second example described below. In addition, the QuickShadow and remote copy operations, snapshot operation, and snapshot pair creation/split, and a differential copy process will be described below with reference to FIGS. 8 to 20.

As described above, according to the first example of remote copy, the differential data of each generation are stored into the sub-volumes 211 to 21n at the local site in accordance with QuickShadow. By doing so, it becomes possible to reduce the storage capacity required on the local site side. Further, since the remote copy is constantly and repeatedly executed from the local site to the remote site, data consistency can be maintained between the multigenerational differential data groups controlled on the individual sides of the local and remote sites. Further, the plurality of sub-volumes 211 to 21n are created at the local site and the pair split can be done even when one sub-volume is used for the remote copy. Therefore, even when there is a generation whose remote copy from the local site side to the remote site side is not yet completed, the differential copy of another generation within the local site can be executed. Further, since the sub-volumes 211 to 21n created at the local site are remote copied, the amount of data to be transferred from the local site side to the remote site side can be reduced.

### SECOND EXAMPLE OF REMOTE COPY

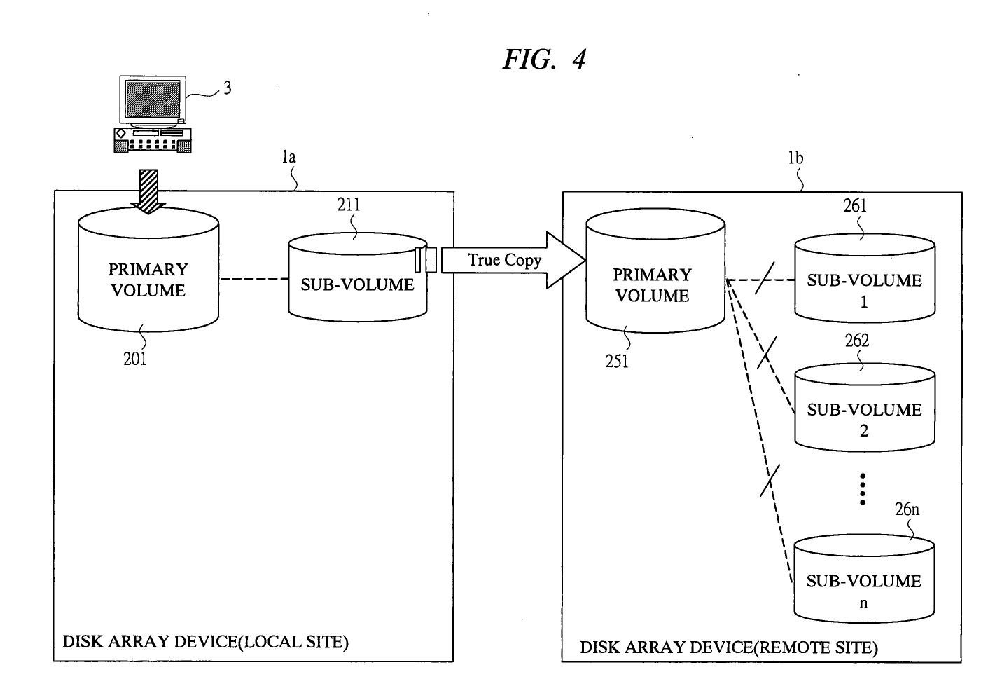

A second example of remote copy between disk array devices in a disk array device group will be described with reference to FIG. 4. FIG. 4 is an explanatory diagram showing the second example of the remote copy.

In comparison with the system of FIG. 3, a system of FIG. 4 is characterized in that virtual logical volumes are created in accordance with QuickShadow on the side of the remote copy destination, that is, remote site, not on the side of the local site. This is a different aspect from the first example.

More specifically, in the system of FIG. 4, in a disk array device 1a provided at the local site, a primary volume 201, which is a logical volume, and one sub-volume 211, which is a virtual logical volume, are provided, and a primary volume 251, which is a logical volume, and a plurality of sub-volumes 261, 262, . . . , 26n (“sub-volumes 261 to 26n,” hereafter), which are virtual logical volumes in accordance with QuickShadow, are provided for the sub-volume 211 in a disk array device 1b of the remote site. The remote copy is performed from the sub-volume 211 on the local site side to the primary volume 251 on the remote site side.

In this case, the CPU 101, which executes the control program 103 of the disk array device 1b on the remote site side, performs the control so that the data to be remote copied transferred from the disk array device 1a on the local site side are stored into the primary volume 251, and the sub-volumes 261 to 26n, which are the plurality of virtual logical volumes, are created from the primary volume 251. In addition, when the data are transferred for the remote copy, the CPU 101 controls the pair creation and the pair split between the primary volume 251 and the sub-volumes 261 to 26n. Therefore, when one path is in a pair state, the pair split of other paths can be done. Further, in the event of creation of each of the sub-volumes 261 to 26n, differential data from the data of the sub-volume of the corresponding day of the previous week is created and stored in each sub-volume.

The second example of the remote copy solves the following problems of the conventional system. More specifically, in the conventional system, since the QuickShadow function is not supported on the disk array device side of the remote site, the differential control cannot be performed. Therefore, because data management using only the primary volume requires a great amount of capacity, it is not effective from the viewpoint of the management and operation.

In view of the above, in the second example according to this embodiment, the QuickShadow function is supported on the remote site side so as to enable the creation of the plurality of sub-volumes. As a result, since the QuickShadow function is supported on the remote site side so as to enable the creation of the plurality of sub-volumes, the efficient differential control can be achieved.

For example, the remote copy of the data of the days of week from Monday to Friday is as follows: (1) the differential in data of Monday (differential data from data of the previous day (data of Friday of the previous week)) is remote copied to the original data on the remote site side; (2) a sub-volume of Monday is shown on the remote site side (real data is in the pool area); (3) data of Tuesday (differential data from the data of Monday (data of the previous day) on the local site side) is remote copied to the remote site after the remote copy of previous data; and thereafter, differentials in data of Wednesday, Thursday, and Friday are similarly remote copied to the remote site after the remote copy of previous data.

More specific operations will be described below in a third example in the form of a combination of the above-described first example and the second example. In addition, the QuickShadow and remote copy operations, snapshot operation, and snapshot pair creation/split, and differential copy process will be described below by reference to FIGS. 8 to 20.

As described above, according to the second example, since only one sub-volume is created at the local site, the storage capacity required on the local site side can be reduced. Further, since the remote copy is constantly and repeatedly executed from the local site to the remote site, data consistency can be maintained in the multigenerational differential data groups controlled on the individual sides of the local and remote sites. In addition, since one sub-volume 211 created at the local site is remote copied, the amount of data to be transferred from the local site side to the remote site side can be reduced. Further, since the differential data of each generation is stored into the sub-volumes 261 to 26n at the remote site in accordance with QuickShadow, the storage capacity required on the remote site side can be reduced.

### THIRD EXAMPLE OF REMOTE COPY

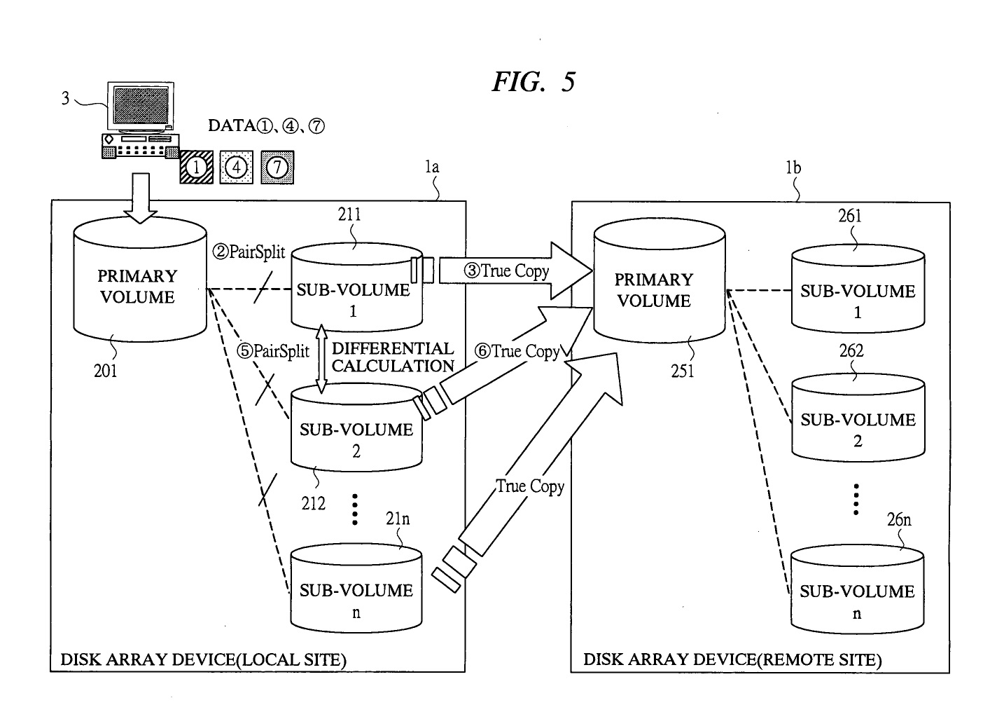

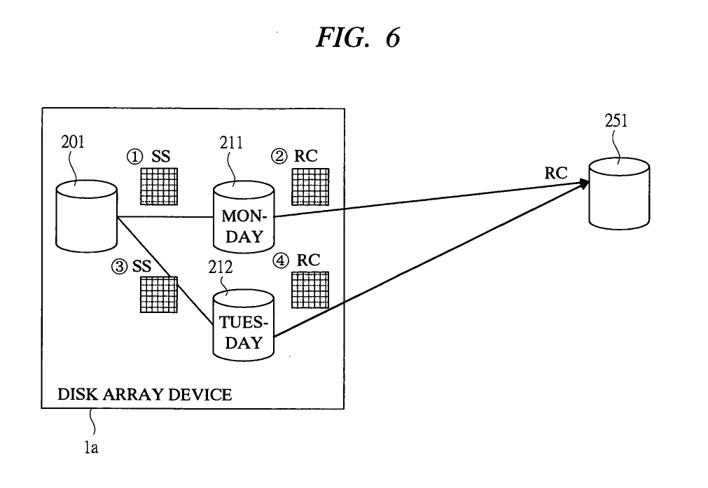

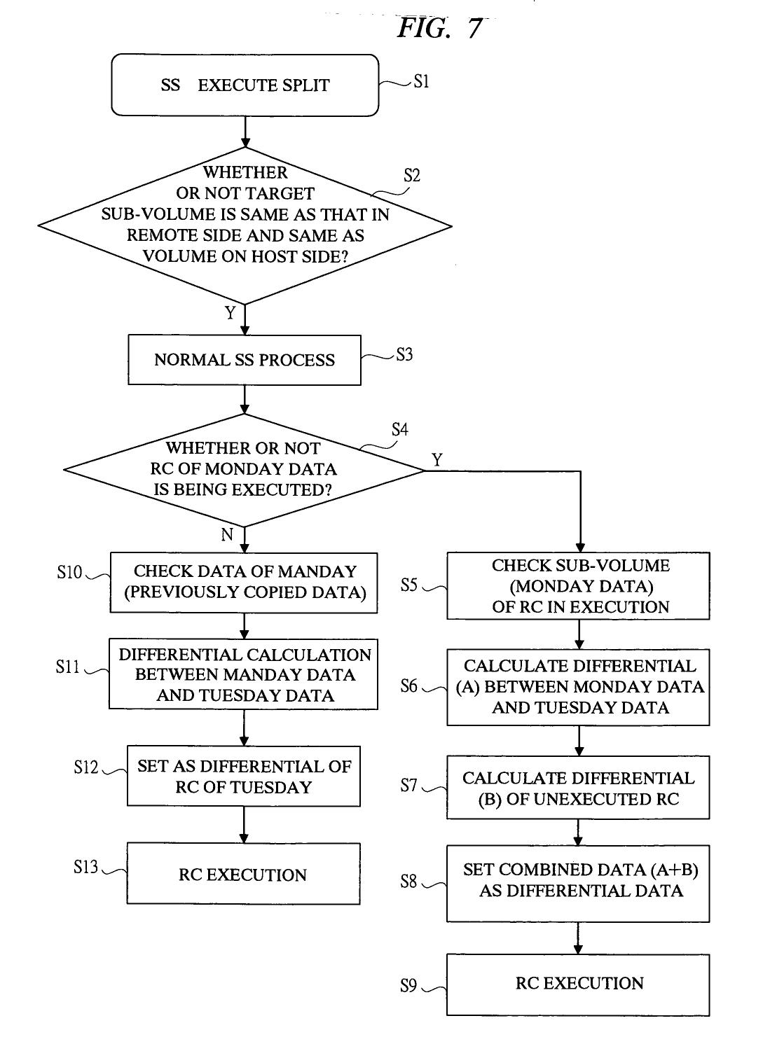

A third example of remote copy between disk array devices in a disk array device group will be described with reference to FIGS. 5 to 7. FIG. 5 is an explanatory diagram showing the third example of the remote copy. FIG. 6 is an explanatory diagram showing a snapshot for each day of week in the third example. FIG. 7 is a flowchart showing the snapshot operation.

In comparison with the systems shown in FIGS. 3 and 4, the system shown in FIG. 5 is characterized in that the feature of the system of FIG. 3 and the feature of the system of FIG. 4 are combined. This aspect is different from the first and second examples.

That is, in the system shown in FIG. 5, a primary volume 201, which is a logical volume, and a plurality of sub-volumes 211, 212, . . . , 21n, which are virtual logical volumes in accordance with QuickShadow, are provided in a disk array device 1a provided at the local site, and one primary volume 251, which is a logical volume, and a plurality of sub-volumes 261, 262, . . . , 26n (“sub-volumes 261 to 26n,” hereafter), which are virtual logical volumes in accordance with QuickShadow, are provided for the plurality of sub-volumes 211 to 21n in a disk array device 1b of the remote site. The remote copy is performed from the plurality of sub-volumes 211 to 21n on the local site side to the one primary volume 251 on the remote site side.

In this case, the CPU 101, which executes the control program 103 of the disk array device 1a on the local site side, performs control so that data of the plurality of sub-volumes 211 to 21n are transferred and remote copied to the primary volume 251 of the disk array device 1b on the remote site side. Then, the CPU 101, which executes the control program 103 of the disk array device 1b on the remote site side, performs the control so that the data to be remote copied transferred from the disk array device 1a on the local site side are stored into the primary volume 251, and the plurality of sub-volumes 261 to 26n are created from the primary volume 251. When the data are transferred for the remote copy, the CPU 101 controls the pair creation and pair split between the primary volume 201 and the plurality of sub-volumes 211 to 21n in the disk array device 1a on the local site side, and when one path is in a pair state, the pair split of other paths can be done. Further, in the event of creation of each of the sub-volumes 261 to 26n, differential data from the previous data of the sub-volume is created and stored in the corresponding sub-volume.

The third example of the remote copy solves the following problems of the conventional system. More specifically, in the conventional system, QuickShadow is performed on the disk array device side of the local site, a plurality of virtual logical volumes are created, and differential data of the individual volumes are managed. In the present state, since the individual volumes perform the remote copy of the differentials from the previously remote copied data, a huge amount of data is stored on the disk array device side of the remote site. Consequently, a large disk storage capacity is required on the remote site side, and the effective management and operation are difficult.

In view of the above, in the third example of the remote copy according to this embodiment, when creating the plurality of sub-volumes 211 to 21n on the side of the disk array device 1a, the differential data is not the differential from the previously remote copied data by each sub-volume but the differential from the previous data (one previous sub-volume). Therefore, the remote copy of a huge amount of data is not necessary and thus, the efficient differential can be achieved.

In the third example of the remote copy, practical procedures for the creation of the sub-volumes and the remote copy of the sub-volumes are as follows.

(1) A first data (circled number 1) is received from the host 3 into the primary volume 201 of the disk array device 1a on the local site side. The disk array device 1a received the data performs the differential check between the first data and the primary volume 201, and the data not saved in the pool area is saved into the pool area.

(2) The disk array device 1a on the local site side performs pair split of a path between the primary volume 201 and a sub-volume (1)211 to create the sub-volume (1)211. In the first pair split, the whole of the first data becomes the differential data, and the first data is stored into the sub-volume (1)211.

(3) The disk array device 1a on the local site side performs the remote copy of the created sub-volume (1)211 to the primary volume 251 of the disk array device 1b on the remote site side. Even during the remote copy, the pair split can be executed in the disk array device 1a on the local site side.

(4) Similar to (1), a fourth data (circled number 4) is received from the host 3 into the primary volume 201 of the disk array device 1a on the local site side.

(5) Similar to (2), the disk array device 1a performs pair split of a path between the primary volume 201 and a sub-volume (2)212 to create the sub-volume (2)212. At this time, even during the remote copy of (3), pair split can be executed. The sub-volume (2)212 is the differential from the sub-volume (1)211, and the differential data from the sub-volume (1)211 is stored in the sub-volume (2)212.

Similar to (3), the disk array device 1a on the local site side performs the remote copy of the created sub-volume (2)212 (differential data from the sub-volume (1)211) to the primary volume 251 of the disk array device 1b on the remote site side.

(7) For the subsequent data, seventh data (circled number 7) and the like received from the host 3 are stored into the primary volume 201, the differential from the previous sub-volume is calculated in each individual sub-volume to create the corresponding sub-volume, and the sub-volume is remote copied to the primary volume on the remote site side.

Consequently, the plurality of sub-volumes are created, which enables the pair split during the remote copy. In an event of the pair split, since the differential from the previous sub-volume is calculated to create the sub-volume, only the differential data from the previous sub-volume is remote copied. In this manner, the amount of transfer data can be reduced, and concurrently, the storage capacity on the remote site side can be reduced. Further, the differential management on the remote site side can be achieved.

For example, the remote copy of the data of each day of the week from Monday to Friday is as follows: (1) the differential in data of Monday (differential data from data of Friday on the local site side (data of Friday of previous week)) is remote copied to the original data on the remote site side; (2) a sub-volume of Monday is shown on the remote site side (real data is in the pool area); (3) the differential data of Tuesday (differential data from data of Monday (data of the previous day) on the local site side) is remote copied to the original data on the remote site side; and (4) a sub-volume of Tuesday is shown on the remote site side (real data is in the pool area); and thereafter, differentials in data of Wednesday, Thursday, and Friday are similarly remote copied to the original data on the remote site side.

In the third example of the remote copy, it is necessary to set a plurality of pairs of remote copies on the local site side. However, on the remote site side, the common primary volume is set as a target of the remote copy. When a primary volume in accordance with QuickShadow on the local site side and a primary volume on the remote site side are common, the differential management is shared.

Here, an example focusing only on Monday and Tuesday will be described with reference to FIG. 6. The Snapshot is performed for each of Monday and Tuesday, and the differential from the previous remote copy data is calculated. In the case where the snapshot is performed on Tuesday, the third snapshot data (circled number 3) is the differential from the first snapshot data (circled number 1) of Monday (differential is calculated when performing the snapshot). The fourth remote copy data (circled number 4) of Tuesday is the differential between the second remote copy data (circled number 2) which is remote copied on Monday and the third snapshot data of Tuesday. At this event, since the data of Tuesday is created by the remote copy of the differential from the data of Monday, the differential between the second remote copy data which is remote copied on Monday and the third snapshot data which is subjected to the snapshot on Tuesday is set as the remote copy data of Tuesday.

In an event that the remote copy of Monday is suspended, untransferred data which is not remote copied is calculated at the snapshot of Tuesday and is set as the third snapshot data of Tuesday. Similarly, when performing the snapshot of Tuesday during the remote copy of Monday, the differential from the remote copy data of Monday is calculated when performing the snapshot of Tuesday and is set as the remote copy data of Tuesday.

More specifically, as shown in FIG. 7, the snapshot split is first executed at the local site for each day of the week (S1). If a target sub-volume is the same as that on the remote site side and is also the same as a logical volume on the host side (S2), the normal snapshot process is performed (S3).

Subsequently, the system determines whether or not remote copy for the data of Monday is being executed (S4). If the remote copy operation is being executed (YES), the sub-volume (data of Monday) of the remote copy is checked (S5), and differential between the data of Monday and data of Tuesday is calculated (S6). The calculated value is represented by A. Further, differential of not remote-copied part is calculated (S7). The calculated value is represented by “B”.

Then, the data obtained by adding the two calculated values A and B is set as differential data (S8). Thereafter, the remote copy of the differential data is executed from the local site to the remote site (S9).

On the other hand, if the result of the determination at S4 is that the remote copy is not under execution (NO), the data of Monday (previously copied data) is checked (S10) and differential between the data of Monday and data of Tuesday is calculated (S11). The calculated data is then set as the differential of the remote copy of Tuesday (S12). Then, the remote copy of the differential data from the local site to the remote site is executed (S13).

In the above, the example focusing only on Monday and Tuesday has been described. However, in the case where the remote copy is performed for data of each day of the week from Monday to Friday and in the case where the remote copy is performed for data of each day of the week including Saturday and Sunday, that is, from Monday to Sunday, the common differential management by the volumes of several generations can be achieved by the process similar to the above.

Thus, according to the third example of the remote copy, the combined effects of the first and second examples can be achieved. Thereby, similar to the first and second examples, the storage capacity required on the local site side can be reduced, data consistency between the multigenerational differential data groups managed on each of the local site side and remote site side can be maintained. Additionally, even in the case where a generation not completely remote copied from the local site side to the remote site side is present, the differential copy of another generation can be executed within the local site. Further, the amount of data to be transferred from the local site side to the remote site side can be reduced, and the storage capacity required on the remote site side can be reduced.

(Operation from Quickshadow to Remote Copy)

An example of operation from QuickShadow to remote copy will be described with reference to FIG. 8. FIG. 8 is an explanatory diagram showing the operation from quick shadow to remote copy.

A practical operation of QuickShadow in the disk array device and the remote copy to another disk array device are performed in the following manner. Firstly, when a write to a primary volume 201 is performed, data before the write is transcribed to a pool volume 205, and information thereof is stored into a storage section 206 of the snapshot data. When the primary volume 201 and a virtual volume 211, which is a virtual volume, are set into a pair state from the above-described split state, information of the correlation between the primary volume 201 and the pool volume 205 is stored into the virtual volume 211. Then, in the event of remote copy creation, the remote copy of data to the primary volume 251 which is a logical volume to be the destination of the remote copy is performed in accordance with the information stored in the virtual volume 211.

(Snapshot Operation)

The primary volume 201 is used for normal operations and is a logical unit (P-VOL: primary volume) to be the target of data I/O from the host 3. When the write to the primary volume 201 is performed, it is determined whether or not the data before being updated needs to be copied to the pool volume 205 by referring to the snapshot control table. That is, when the data at the time of snapshot creation is already written in the pool volume 205, the data in the primary volume 201 need not be copied to the pool volume 205.

Differential information control blocks of the snapshot control table are allocated in a one-to-one manner to the pool volume 205 and are provided in a control area of the memory 102. The differential information control blocks are partitioned for each block of the pool volume 205 (64 Kbytes/block, for example), and a table is provided to each of the blocks. With the tables, the multigenerational differential data can be referenced by tracing the addresses in which the information indicating the generation of the differential data recorded at a position corresponding to a block of pool volume 205 is recorded.

The pool volume 205 is formed of volumes registered in the pool area. By the pool volume 205, data in the primary volume 201 at the time of snapshot creation is shown as if it is logically copied. Hence, the generation to which data in the pool volume 205 belongs as differential data can be known from the differential information control block.

Accordingly, when writing data into the primary volume 201, the snapshot control table is first referenced to determine whether pre-update data needs to be copied to the pool volume 205. If it is determined that the pre-update data need not be copied to the pool volume 205, the data is written into the primary volume 201. On the other hand, if it is determined that the pre-update data needs to be copied to the pool volume 205, the data is written into the primary volume 201 after the pre-update data is copied to the pool volume 205.

In the event of access to the virtual volume (V-VOL) 211, a primary-volume address table is referenced, and an address of the differential information control block is specified in accordance with a block address of the virtual volume (equivalent to a block address of the primary volume) to be the access target. Then, in accordance with the address of the differential information control block, it is determined whether or not differential data of the generation to be the access target is present.

If the differential data of desired generation is present, the differential data is read from the address of the pool volume 205 corresponding to the address of the differential information control block to provide an image of the virtual volume 211. On the other hand, if the referenced data is not the differential data of desired generation, the differential data of desired generation is searched with reference to link addresses for other differential data. If any of referenced differential data is not of the desired generation, data recorded in the primary volume 201 at that time is provided as the data of the virtual volume 211.

Further, in the above-described configuration, actual data of the virtual volume 211 created in accordance with the snapshot function is present in the snapshot primary volume 201 and the pool volume 205 storing differential data. Consequently, when executing the remote copy from the virtual volume 211, the copy can be implemented by selecting the primary volume 201 and the pool volume 205 at the execution time of the remote copy.

(Snapshot Pair Creation/Cancellation)

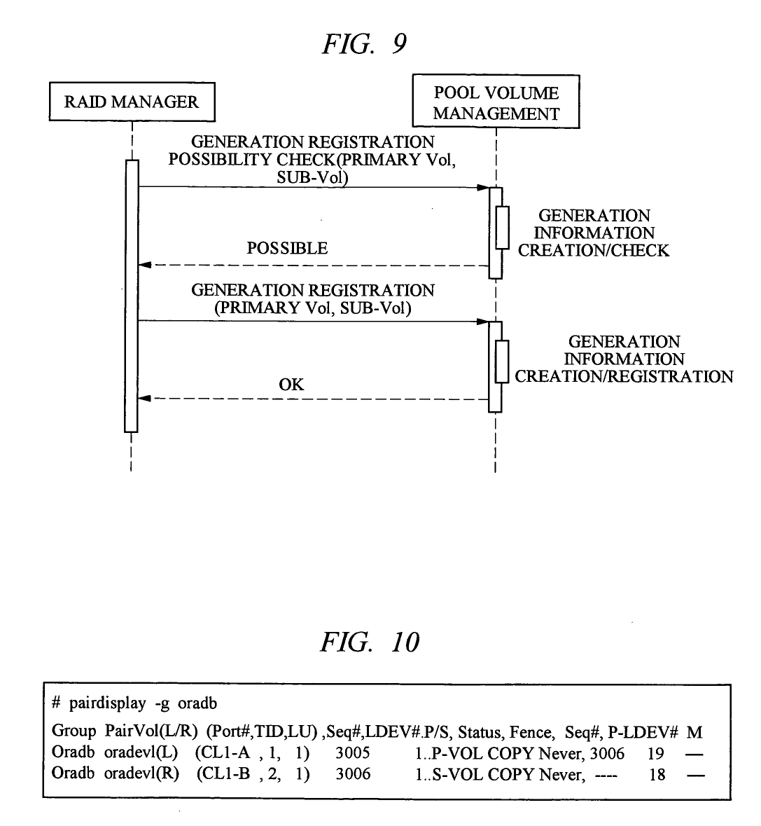

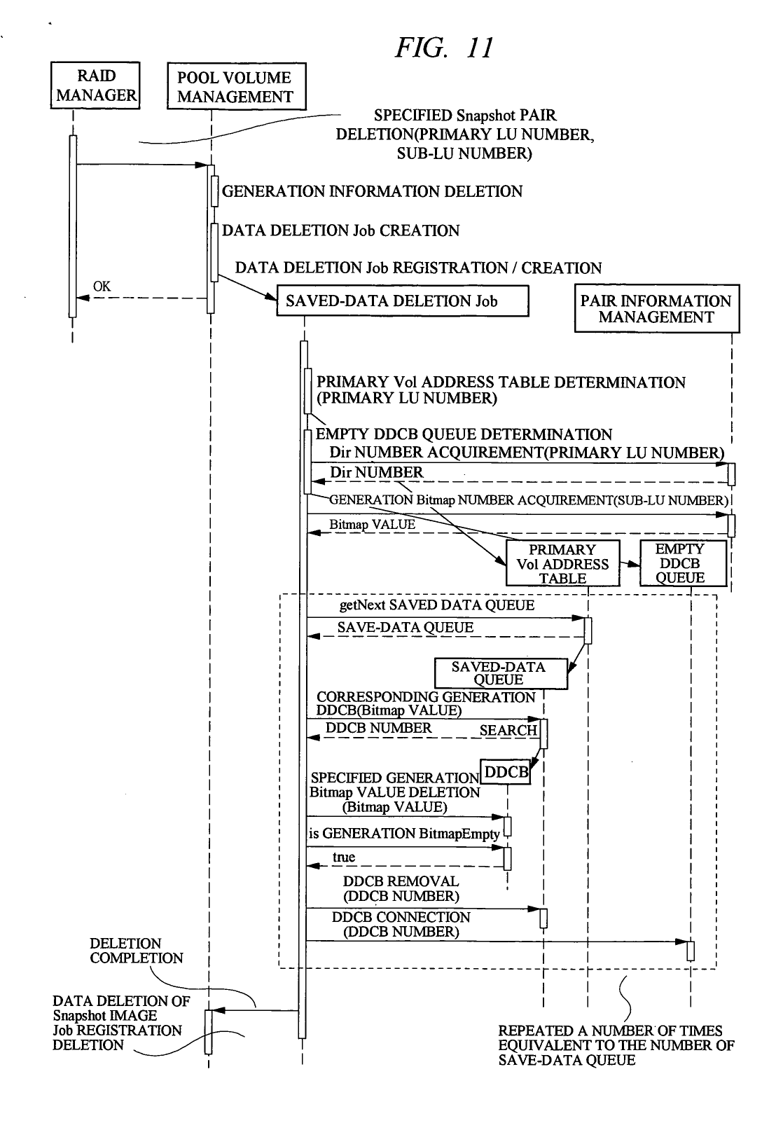

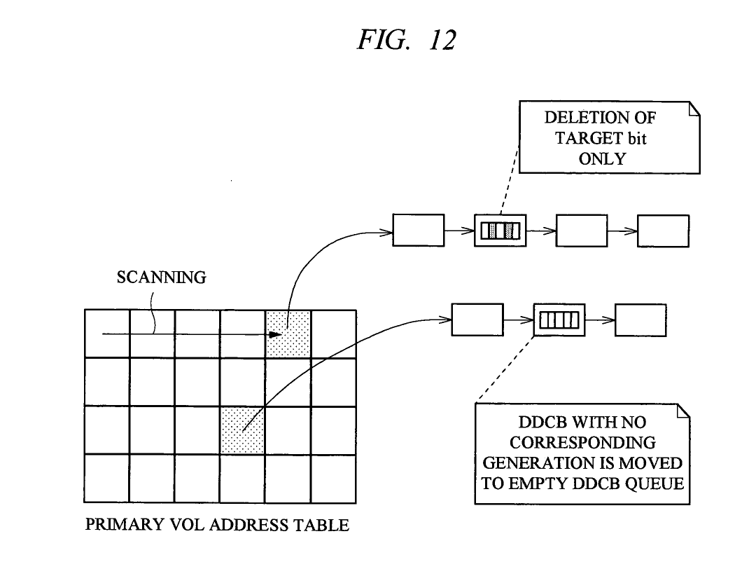

Examples of snapshot pair creation/cancellation operation will be described with reference to FIGS. 9 to 12. FIG. 9 is an explanatory diagram showing a snapshot pair creation registration sequence. FIG. 10 is an explanatory diagram showing display of a snapshot pair generation. FIG. 11 is an explanatory diagram showing a snapshot pair cancellation sequence. FIG. 12 is an explanatory diagram showing an operation of a saved data deletion job program.

A snapshot pair creation/cancellation function is composed of (1) snapshot pair creation and (2) snapshot pair cancellation.

(1) Snapshot Pair Creation

In the snapshot pair creation, creation/registration of generation information is performed. As shown in FIG. 9, a snapshot pair generation registration sequence is performed between the RAID manager program 131 and the pool volume management program 142. In the generation registration of a snapshot pair, the pool volume management program 142 provides a check function for registration possibility/impossibility. The content of the check function is to check the presence of usable bits in generation bitmap creation.

Firstly, the RAID manager program 131 issues a request to the pool volume management program 142 for a generation registration possibility/impossibility check (Primary Vol (volume), Sub-Vol). Upon receipt of the request, the pool volume management program 142 performs a generation information creation/check. If the registration is possible, the pool volume management program 142 issues to the RAID manager program 131 a response indicating that the registration is possible.

Upon receipt of the response, the RAID manager program 131 issues a request to the pool volume management program 142 for the generation registration (Primary Vol, Sub-Vol). Upon receipt of the request, the pool volume management program 142 performs generation information creation/registration, and issues an OK response to the RAID manager program 131 after the creation/registration. Then, the creation/registration of generation information are completed.

FIG. 10 shows an example of input and output results in the snapshot pair creation. That is, in the display command of a pair-state (Pairdisplay), items such as Group, PairVol(L/R), (Port#, TID, LU), Seq#, LDEV#.P/S, Status, Fence, Seq#, P-LDEV#, and M, are input, and the output result thereof is displayed.

(2) Snapshot Pair Cancellation

In the snapshot pair cancellation, factors for the pair cancellation include, for example, user-specified snapshot pair cancellation, and snapshot pair cancellation executed to secure a free storage space when the used amount of the pool-volume has exceeded a reference value. In the event of the pair cancellation, the pool volume management program 142 performs the deletion of generation information of the pair to be cancelled, the saved data deletion of the pair to be cancelled, and the collection of differential information control block.

In the snapshot pair cancellation, it is expected that it takes much time for the saved data deletion because the deletion includes the process of scanning each save-data queues of the primary-volume address table and returning the corresponding differential information control block to an empty differential information control block queue. The saved data deletion is performed by means of a method wherein a data deletion job program is created and the job program is used to perform the saved-data deletion and a method of allocating one deletion job program to a pair specified to be deleted.

As shown in FIG. 11, the sequence of deleting a specified snapshot pair is performed among, for example, the RAID manager program 131, the pool volume management program 142, the pair information management program 141, the saved data deletion job program, a primary Vol address table, the save-data queue, a DDCB (differential information control block), and an empty DDCB queue.

When a snapshot pair to be cancelled is specified, the pool volume management program 142 sets the state of generation information of the corresponding pair to an under-deletion state. Thereafter, a saved data deletion job program is created. The deletion job program performs various operations such as scanning a corresponding primary Vol address table; when a save-data queue is found, searching a DDCB corresponding to the generation data to be deleted and tracing the save-data queue; when a corresponding DDCB is not found in the save-data queue, searching a subsequent save-data queue and continually scanning a sub-Vol address table; when the corresponding DDCB is present in the save-data queue, deleting a value corresponding to the generation of the deletion data from a generation bitmap; when the generation bitmap has become empty, moving the DDCB to an empty DDCB queue; and when the save-data queue is in a locked state (another job is being used), ceasing the deletion process until the queue is released.

More specifically, as shown in FIG. 12, the saved data deletion job program executes the following:

for Save Data Queue in corresponding primary volume Address
Table:

while 1:

if Save Data Queue is locked;

wait

else:

break

for DDCB in Save Data Queue:

if DDCB is Deletion Target Generation:

DDCB. Delete Deletion Target Generation Bit from

Generation Bitmap

if DDCB. Generation Bitmap Information is Empty:

move DDCB to Empty DDCB

A practical sequence is shown in FIG. 11.

Firstly, the RAID manager program 131 issues a request to the pool volume management program 142 for a deletion of the cancellation-specified snapshot pair (Primary-LU (logical unit) number, Sub-LU number). Upon receipt of the request, the pool volume management program 142 deletes generation information, creates a data deletion job program registration, and issues an OK response to the RAID manager program 131 after the creation.

The saved data deletion job program performs a determination of a primary-volume address table (Primary-LU number) and a determination of an empty DDCB queue. In the determination of the empty DDCB queue, the job program issues a request to the pair information management program 141 for the Div (device) number acquirement (Primary-LU number), thereby acquiring the Div number. Further, the saved data deletion job program issues a request to the pair information management program 141 for the acquirement of the generation Bitmap value (sub LU number), thereby acquiring the bitmap value.

Subsequently, the saved data deletion job program repeats the following processes a number of times equivalent to the number of saved data, that is: acquirement of a subsequent save-data queue associated with the primary Vol address table; acquirement of a corresponding generation DDCB number associated with the save-data queue; deletion of a specified generation bitmap value associated with a DDCB; removal of DDCB associated with the save-data queue; and connection of the DDCB associated with an empty DDCB queue. These processes are repeatedly executed a number of times equivalent to the number of saved data.

Then, the saved data deletion job program deletes the data deletion job program of the registration of the snapshot-image and issues a deletion completion response to the pool volume management program 142.

(Differential Copy Process)

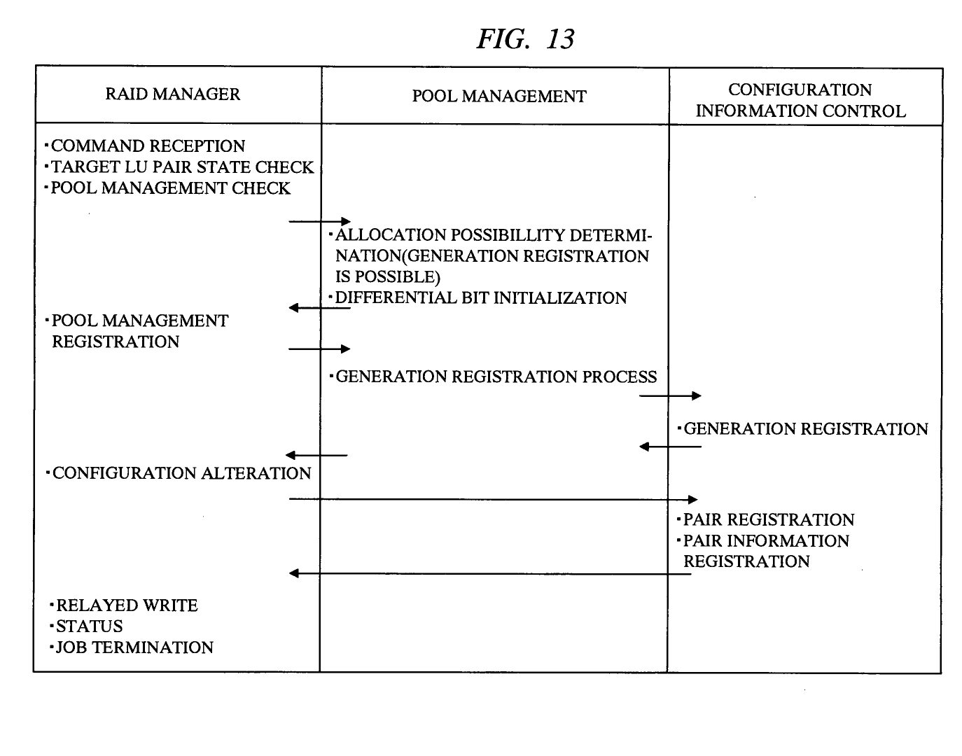

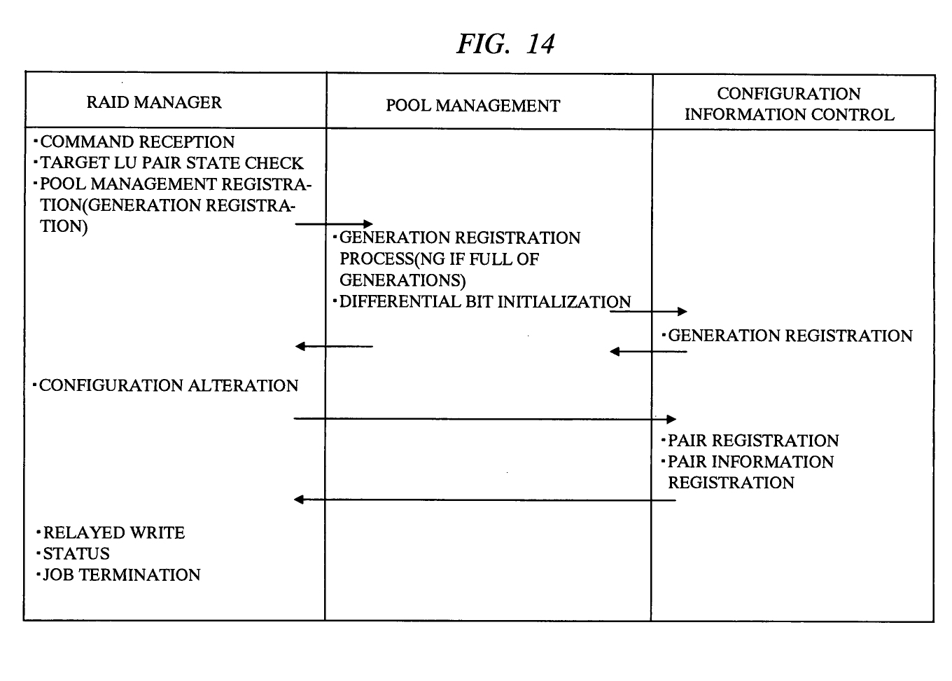

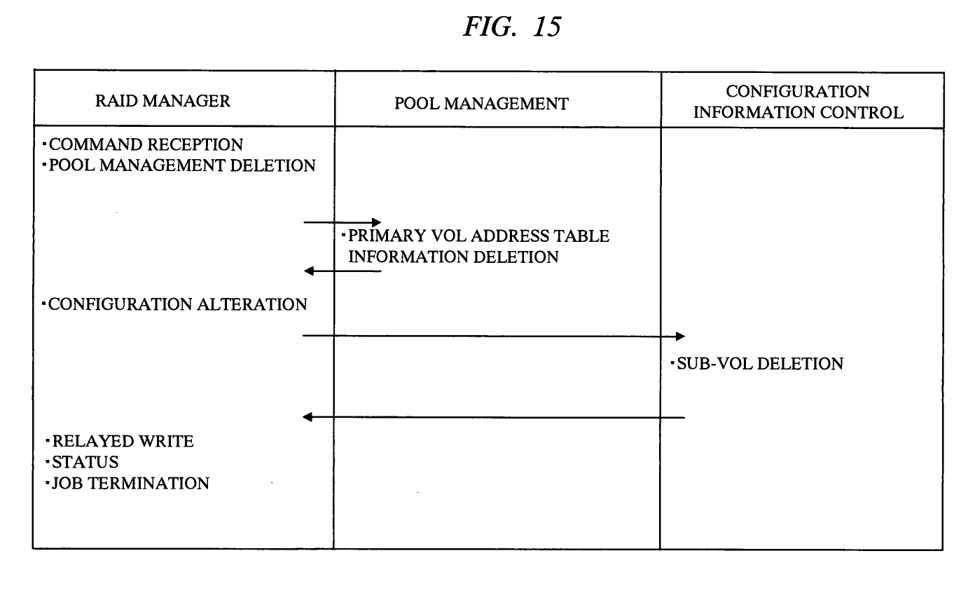

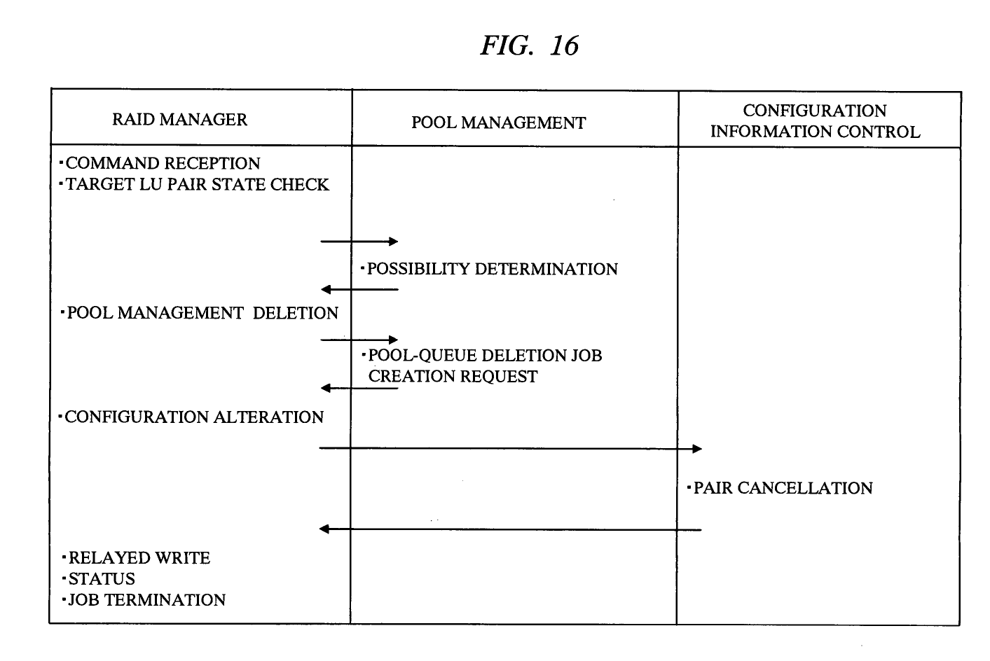

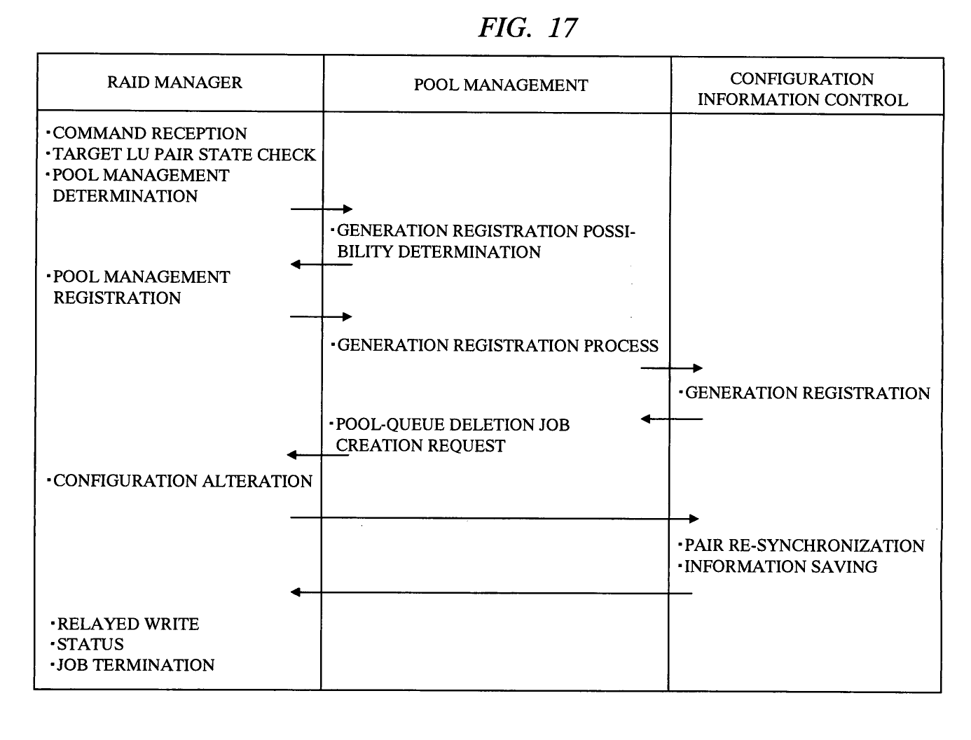

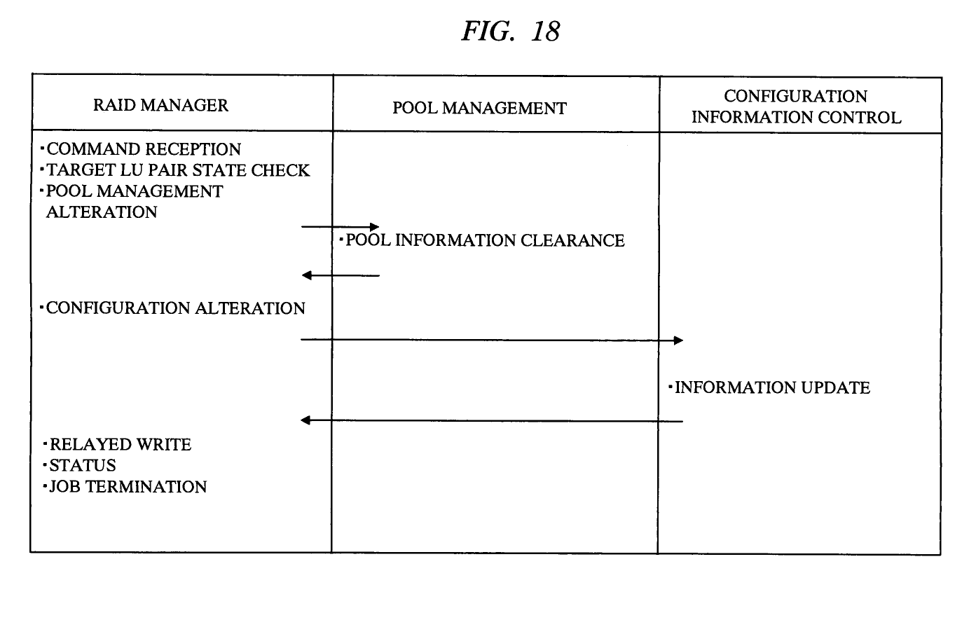

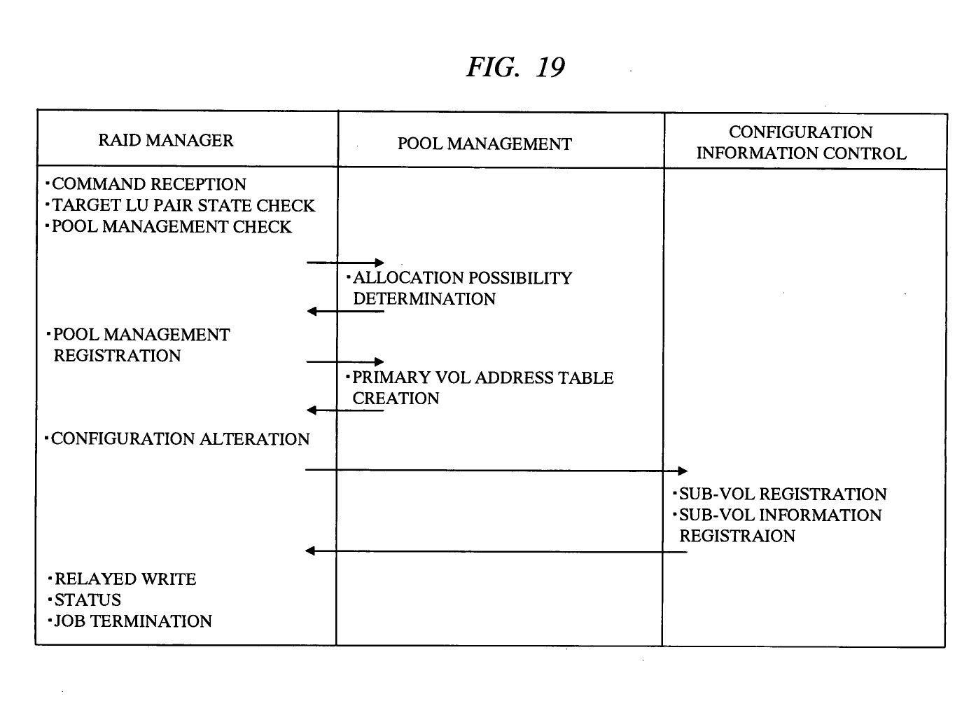

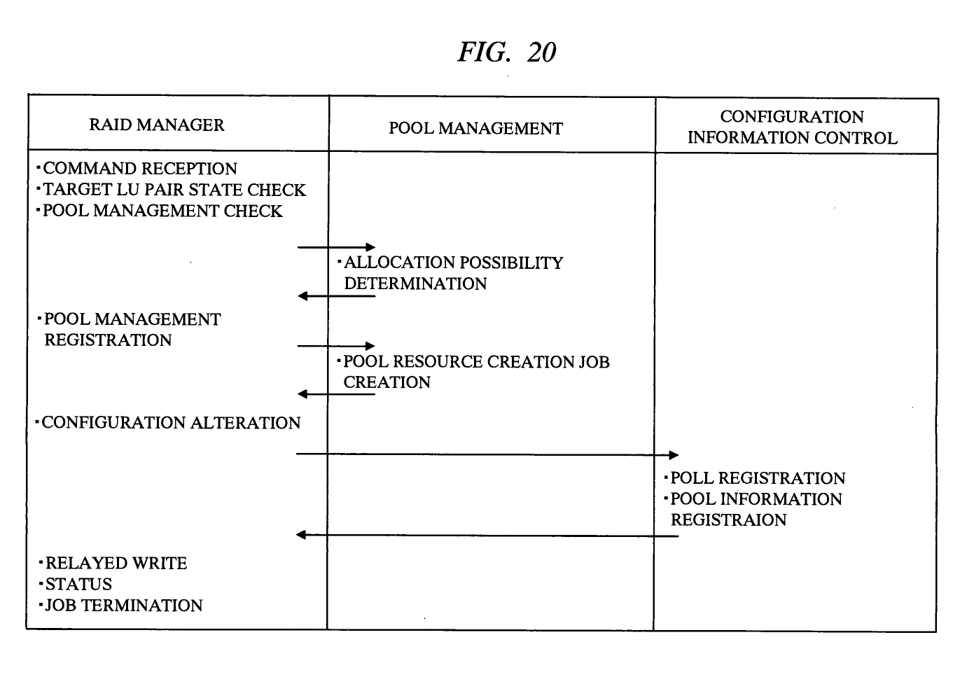

An example of operation of the differential copy process will be described with reference to FIGS. 13 to 20. FIG. 13 is an explanatory diagram showing a pair (first pair) forming process sequence. FIG. 14 is an explanatory diagram showing a pair (second and subsequent pair) forming process sequence. FIG. 15 is an explanatory diagram showing a sub-VOL deletion process sequence. FIG. 16 is an explanatory diagram showing a pair cancellation process sequence. FIG. 17 is an explanatory diagram showing a pair re-synchronization process sequence. FIG. 18 is an explanatory diagram showing a pool cancellation process sequence. FIG. 19 is an explanatory diagram showing a sub-VOL creation process sequence. FIG. 20 is an explanatory diagram showing a pool definition process sequence.

In the differential copy, various processes are executed including (1) pair formation (first pair), (2) pair formation (second and subsequent pair), (3) sub-VOL deletion, (4) pair cancellation, (5) pair re-synchronization, (6) pool cancellation, (7) sub-VOL creation, and (8) pool definition, for example. These process sequences are controlled at the initiative of a MODE SELECT command, and therefore, the call of configuration information control program 140 such as the pair registration is performed from the RAID manager program 131 of mode select not from the pool management program 150. However, since the generation registration process is controlled by the pool management program 150, the call thereof is performed from the pool management program 150.

As shown in FIGS. 13 to 20, these process sequences are executed among the RAID manager program 131, the pool management program 150, and the configuration information control program 140.

(1) Pair Formation (First Pair)

The pair (first pair) formation process is executed in accordance with the sequence of FIG. 13. In this process, since the pool management information needs to be created in the event of the first pair formation, the pool management program 150 is called.

Firstly, upon receipt of a command from the host 3, the RAID manager program 131 issues a request to the pool management program 150 for state check of the target LU pair and pool management check. Upon receipt of the request, the pool management program 150 determines whether or not the allocation is possible; and if the allocation is possible, the pool management program 150 issues to the RAID manager program 131 a response indicating so, thereby initializing differential bits.

The RAID manager program 131 then issues a request to the pool management program 150 for pool management registration. Upon receipt of the request, the pool management program 150 issues a request to the configuration information control program 140 for a generation registration process. Upon receipt of the request, the configuration information control program 140 performs the generation registration. After the completion of the registration, the configuration information control program 140 issues a registration completion response to the RAID manager program 131 through the pool management program 150.

Subsequently, the RAID manager program 131 issues a request to the configuration information control program 140 for configuration alteration. Upon receipt of the request, the configuration information control program 140 performs pair registration and pair information registration. After the completion of the registration, the configuration information control program 140 issues a registration completion response to the RAID manager program 131.

Further, the RAID manager program 131 executes relayed writing, status report, and job termination.

(2) Pair Formation (Second and Subsequent Pair)

A pair (second and subsequent pair) formation process is executed in accordance with the sequence of FIG. 14. In this process, the formation of the second and subsequent pair includes only the generation registration as the pool management process.

Firstly, upon receipt of a command from the host 3, the RAID manager program 131 issues a request to the pool management program 150 for state check of the target LU pair and pool management registration (generation registration). Upon receipt of the request, the pool management program 150 issues a request to the configuration information control program 140 for generation registration process (NG if full of generations). Upon receipt of the request, the configuration information control program 140 performs the generation registration. After completion of the registration, the configuration information control program 140 issues a registration completion response to the RAID manager program 131 through the pool management program 150. The following forming process is similar to that of the first pair forming process.

(3) Sub-VOL Deletion

The sub-VOL deletion process is executed in accordance with a sequence of FIG. 15. In this process, if there is another primary VOL and a final sub-VOL is set for the corresponding primary VOL, the primary Vol address table is deleted. Otherwise, only configuration alteration is performed.

Firstly, upon receipt of a command from the host 3, the RAID manager program 131 issues a request to the pool management program 150 for pool management deletion. Upon receipt of the request, the pool management program 150 performs primary-VOL address table information deletion. After the completion of the deletion, the pool management program 150 issues a deletion completion response to the RAID manager program 131.

Subsequently, the RAID manager program 131 issues a request to the configuration information control program 140 for configuration alteration. Upon receipt of the request, the configuration information control program 140 performs sub-VOL deletion. After the completion of the deletion, the configuration information control program 140 issues a registration completion response to the RAID manager program 131.

In the generation registration cancellation, upon the termination of a pool-management deletion job program, the configuration information control program 140 is called from the pool management program 150.

(4) Pair Cancellation

The pair cancellation process is execution in accordance with a sequence of FIG. 16. In this process, since the old data deletion takes a time, the deletion process is not performed at the extension of MODE SELECT, but is implemented in the after-operation.

Firstly, upon receipt of a command from the host 3, the RAID manager program 131 issues a request to the pool management program 150 for state check of the target LU pair. Upon receipt of the request, the pool management program 150 determines whether or not the pair cancellation is possible, and if the cancellation is possible, the pool management program 150 issues a response indicating so to the RAID manager program 131.

Subsequently, the RAID manager program 131 issues a request to the pool management program 150 for pool management deletion. Upon receipt of the request, the pool management program 150 issues a request to the RAID manager program 131 for creation of a pool-queue deletion job program.

Then, the RAID manager program 131 issues a request to the configuration information control program 140 for configuration alteration. Upon receipt of the request, the configuration information control program 140 performs the pair cancellation. After the completion of the cancellation, the configuration information control program 140 issues a cancellation completion response to the RAID manager program 131.

In the generation registration cancellation, upon termination of the pool-management information deletion job program, the configuration information control program 140 is called from the pool management program 150.

(5) Pair Re-Synchronization

The pair re-synchronization process is executed in accordance with the sequence of FIG. 17. In this process, since the old data deletion takes time, the process is practically implemented by allocating a new generation.

Firstly, upon receipt of a command from the host 3, the RAID manager program 131 issues a request to the pool management program 150 for state check of the target LU pair and pool management determination. Upon receipt of the request, the pool management program 150 determines whether or not the generation registration is possible, and if the registration is possible, the pool management program 150 issues a response indicating so to the RAID manager program 131.

The RAID manager program 131 then issues a request to the pool management program 150 for pool management registration. Upon receipt of the request, the pool management program 150 issues a request to the configuration information control program 140 for generation registration. Upon receipt of the request, the configuration information control program 140 performs the generation registration. After the completion of the registration, the configuration information control program 140 issues a registration completion response to the pool management program 150. Upon receipt of the response, the pool management program 150 issues a request to the RAID manager program 131 for creation of a pool-queue deletion job program.

Then, the RAID manager program 131 issues a request to the configuration information control program 140 for configuration alteration. Upon receipt of the request, the configuration information control program 140 performs the pair re-synchronization and information saving. After the completion of the re-synchronization and the saving, the configuration information control program 140 issues a response regarding the completion of the re-synchronization and the saving to the RAID manager program 131.

(6) Pool Cancellation

The pool cancellation process is executed in accordance with the sequence of FIG. 18. In this process, program information is cleared upon completion of the pool cancellation.

Firstly, upon receipt of a command from the host 3, the RAID manager program 131 issues a request to the pool management program 150 for state check of the target LU pair and pool management alteration. Upon receipt of the request, the pool management program 150 performs pool information clearance, and issues a clearance completion response to the RAID manager program 131 after the completion of the clearance.

Then, the RAID manager program 131 issues a request to the configuration information control program 140 for configuration alteration. Upon receipt of the request, the configuration information control program 140 performs an information update. After completion of the update, the configuration information control program 140 issues an update completion response to the RAID manager program 131.

(7) Sub-VOL Creation

The sub-VOL creation process is executed in accordance with a sequence of FIG. 19. In this process, first sub-VOL creation is performed for a target primary VOL, and a primary VOL address table is created. For the second and subsequent sub-VOLs, the primary VOL address table need not be created.

Firstly, upon receipt of a command from the host 3, the RAID manager program 131 issues a request to the pool management program 150 for state check of the target LU pair and pool management check. Upon receipt of the request, the pool management program 150 determines whether or not allocation is possible, and if the allocation is possible, the pool management program 150 issues a response indicating so to the RAID manager program 131.

The RAID manager program 131 then issues a request to the pool management program 150 for pool management registration. Upon receipt of the request, the pool management program 150 performs primary VOL address table creation. After the completion of the creation, the pool management program 150 issues a creation completion response to the RAID manager program 131.

The RAID manager program 131 then issues a request to the configuration information control program 140 for configuration alteration. Upon receipt of the request, the configuration information control program 140 performs sub-VOL registration and sub-VOL information registration. After the completion of the registration, the configuration information control program 140 issues a registration completion response to the RAID manager program 131.

(8) Pool Definition

The pool definition process is executed in accordance with the sequence of FIG. 20. In this process, a pool resource is created. Since the creation takes time, it is performed in the after-operation.

Firstly, upon receipt of a command from the host 3, the RAID manager program 131 issues a request to the pool management program 150 for state check of the target LU pair and pool management check. Upon receipt of the request, the pool management program 150 determines whether or not the allocation is possible, and if the allocation is possible, the pool management program 150 issues a response indicating so to the RAID manager program 131.

Subsequently, the RAID manager program 131 issues a request to the pool management program 150 for pool management registration. Upon receipt of the request, the pool management program 150 performs the creation of pool-resource creation job program. After the completion of the creation, the pool management program 150 issues a creation completion response to the RAID manager program 131.

Then, the RAID manager program 131 issues a request to the configuration information control program 140 for configuration alteration. Upon receipt of the request, the configuration information control program 140 performs pool registration and pool information registration. After the completion of the registration, the configuration information control program 140 issues a registration completion response to the RAID manager program 131.

In the foregoing, the invention made by the inventors of the present invention has been concretely described based on the embodiments. However, it is needless to say that the present invention is not limited to the foregoing embodiments and various modifications and alterations can be made within the scope of the present invention.

What is claimed is:

1. A disk array device group, comprising: a first disk array device present in a first location; and a second disk array device present in a second location, wherein remote copy is performed from said first disk array device to said second disk array device, and at least one of said first disk array device and said second disk array device comprises:
an upper interface that is connected to an upper machine and that receives data from said upper machine;
a memory that is connected to said upper interface and that preserves data communicated with said upper machine and control information regarding data communicated with said upper machine;
a disk interface that is connected to said memory and that controls the data communicated with the upper machine to be read and written from and to said memory;
a plurality of disk drives that are connected to said disk interface and that store data sent from said upper machine under control of said disk interface; and
a control processor that controls read and write of data from and to a first logical volume created by using storage areas of said plurality of disk drives, performs control so that past data stored in said first logical volume is written as differential data of each generation to a second logical volume, and controls said differential data by providing a snapshot control table, which is used to control relationships of said differential data of each generation stored in said second logical volume, into an area of said memory, and
a function to create at least a first virtual logical volume for storing first generation data and a second virtual logical volume for storing second generation data in accordance with said snapshot control table is provided.

2. The disk array device group according to claim 1,
wherein said first disk array device comprises said upper interface, said memory, said disk interface, said plurality of disk drives, said control processor, and has a function to create said first virtual logical volume and said second virtual logical volume, and
said control processor of said first disk array device has a function to perform control so that data of said first virtual logical volume is transferred to be remote copied to a third logical volume of said second disk array device and data of said second virtual logical volume is transferred to be remote copied to a fourth logical volume of said second disk array device.

3. The disk array device group according to claim 2,
wherein said control processor of said first disk array device has a function to, when the data are transferred to be remote copied to said second disk array device, control pair creation and pair split between said first logical volume and said first virtual logical volume and between said first logical volume and said second virtual logical volume.

4. The disk array device group according to claim 2,
wherein said control processor of said first disk array device has a function to, when creating said first virtual logical volume and said second virtual logical volume, create differential data from previous data of said first virtual logical volume and store the differential data into said first virtual logical volume and to create differential data from previous data of said second virtual logical volume and store the differential data into said second virtual logical volume.

5. The disk array device group according to claim 1,
wherein said second disk array device comprises said upper interface, said memory, said disk interface, said plurality of disk drives, and said control processor, and has a function to create said first virtual logical volume and said second virtual logical volume, and
said control processor of said second disk array device has a function to perform control so that data transferred from said first disk array device to be remote copied is stored into a fifth logical volume and said first virtual logical volume and said second virtual logical volume are created from said fifth logical volume.

6. The disk array device group according to claim 5,
wherein said control processor of said second disk array device has a function to, when the data are transferred from said first disk array device to be remote copied, control pair creation and pair split between said fifth logical volume and said first virtual logical volume and between said fifth logical volume and said second virtual logical volume.

7. The disk array device group according to claim 5,
wherein said control processor of said second disk array device has a function to, when creating said first virtual logical volume and said second virtual logical volume, create differential data from previous data of said first virtual logical volume and store the differential data into said first virtual logical volume and to create differential data from previous data of said second virtual logical volume and store the differential data into said second virtual logical volume.

8. The disk array device group according to claim 1,
wherein said first disk array device and said second disk array device each comprises said upper interface, said memory, said disk interface, said plurality of disk drives, and said control processor, and has a function to create said first virtual logical volume and said second virtual logical volume,
said control processor of said first disk array device has a function to perform control so that data of said first virtual logical volume and said second virtual logical volume of said first disk array device are remote copied to a sixth logical volume of said second disk array device, and
said control processor of said second disk array device has a function to perform control to store data transferred from said first disk array device to be remote copied into said sixth logical volume and create said first virtual logical volume and said second virtual logical volume of said second disk array device from said sixth logical volume.

9. The disk array device group according to claim 8,
wherein said control processor of said first disk array device has a function to, when the data are transferred to be remote copied to said second disk array device, control pair creation and pair split between said first logical volume and said first virtual logical volume and between said first logical volume and said second virtual logical volume.

10. The disk array device group according to claim 8,
wherein said control processor of said first disk array device has a function to, when creating said second virtual logical volume, create differential data from data of said first virtual logical volume and store the differential data into said second virtual logical volume.

11. A copy method for a disk array device group,
wherein said disk array device group comprises: a first disk array device present in a first location; and a second disk array device present in a second location, wherein remote copy is performed from said first disk array device to said second disk array device, and at least one of said first disk array device and said second disk array device comprises:
an upper interface that is connected to an upper machine and that receives data from said upper machine;
a memory that is connected to said upper interface and that preserves data communicated with said upper machine and control information regarding data communicated with said upper machine;
a disk interface that is connected to said memory and that controls the data communicated with the upper machine to be read and written from and to said memory;
a plurality of disk drives that are connected to said disk interface and that store data sent from said upper machine under control of said disk interface; and
a control processor that controls read and write of data from and to a first logical volume created by using storage areas of said plurality of disk drives, performs control so that past data stored in said first logical volume is written as differential data of each generation to a second logical volume, and controls said differential data by providing a snapshot control table, which is used to control relationships of said differential data of each generation stored in said second logical volume, into an area of said memory, and
at least a first virtual logical volume for storing first generation data and a second virtual logical volume for storing second generation data are created in accordance with said snapshot control table.

12. The copy method for a disk array device group according to claim 11,
wherein said first disk array device comprises said upper interface, said memory, said disk interface, said plurality of disk drives, said control processor, and has a function to create said first virtual logical volume and said second virtual logical volume, and
said control processor of said first disk array device has a function to perform control so that data of said first virtual logical volume is transferred to be remote copied to a third logical volume of said second disk array device and data of said second virtual logical volume is transferred to be remote copied to a fourth logical volume of said second disk array device.

13. The copy method for a disk array device group according to claim 12,
wherein, when the data are transferred to be remote copied to said second disk array device, said control processor of said first disk array device controls pair creation and pair split between said first logical volume and said first virtual logical volume and between said first logical volume and said second virtual logical volume.

14. The copy method for a disk array device group according to claim 12,
wherein, when creating said first virtual logical volume and said second virtual logical volume, said control processor of said first disk array device creates differential data from previous data of said first virtual logical volume and stores the differential data into said first virtual logical volume and to create differential data from previous data of said second virtual logical volume and store the differential data into said second virtual logical volume.

15. The copy method for a disk array device group according to claim 11,
wherein said second disk array device comprises said upper interface, said memory, said disk interface, said plurality of disk drives, and said control processor, and has a function to create said first virtual logical volume and said second virtual logical volume, and
said control processor of said second disk array device performs control so that data transferred from said first disk array device to be remote copied is stored into a fifth logical volume and said first virtual logical volume and said second virtual logical volume are created from said fifth logical volume.

16. The copy method for a disk array device group according to claim 15,
wherein, when the data are transferred from said first disk array device to be remote copied, said control processor of said second disk array device controls pair creation and pair split between said fifth logical volume and said first virtual logical volume and between said fifth logical volume and said second virtual logical volume.

17. The copy method for a disk array device group according to claim 15,
wherein, when creating said first virtual logical volume and said second virtual logical volume, said control processor of said second disk array device creates differential data from previous data of said first virtual logical volume and stores the differential data into said first virtual logical volume, and creates differential data from previous data of said second virtual logical volume and stores the differential data into said second virtual logical volume.

18. The copy method for a disk array device group according to claim 11,
wherein said first disk array device and said second disk array device each comprises said upper interface, said memory, said disk interface, said plurality of disk drives, and said control processor, and has a function to create said first virtual logical volume and said second virtual logical volume,
said control processor of said first disk array device performs control so that data of said first virtual logical volume and said second virtual logical volume of said first disk array device are remote copied to a sixth logical volume of said second disk array device, and
said control processor of said second disk array device performs control to store data transferred from said first disk array device to be remote copied into said sixth logical volume and create said first virtual logical volume and said second virtual logical volume of said second disk array device from said sixth logical volume.

19. The copy method for a disk array device group according to claim 18,
wherein, when the data are transferred to be remote copied to said second disk array device, said control processor of said first disk array device controls pair creation and pair split between said first logical volume and said first virtual logical volume and between said first logical volume and said second virtual logical volume.

20. The copy method for a disk array device group according to claim 18,
wherein, when creating said second virtual logical volume, said control processor of said first disk array device creates differential data from data of said first virtual logical volume and stores the differential data into said second virtual logical volume.
